(19) United States
(12) Patent Application Publication
(10) Pub. No.: US 2006/0037191 A1
(43) Pub. Date: Feb. 23, 2006

(54) Device coupler of impact to connect aerial handles of electric energy

(75) Inventors: Alexandre Martinez Soriano, Pedra Bela (BR); Joao Augusto Fieire Vieira, Valinhos (BR)

Correspondence Address: NORRIS, MCLAUGHLIN & MARCUS, 875 THIRD AVE, 18TH FLOOR, NEW YORK, NY, 10022, US

(73) Assignee: KRJ Industria E Comercio Ltda., Sao Paulo (BR)

(21) Appl. No.: 10/920,641

(22) Filed: Aug. 18, 2004

(51) Int. Cl. H01R 12/00

(52) U.S. Cl. 29/747; 29/745; 439/66

(57) ABSTRACT

A device coupler of impact to connect aerial handles of electric energy is disclosed, which is the kind that comprises a set of copier with accessories brace for support and connectors parts setting to be applied into the power system between the electrical cables, the copier is made up by a piston with a breech that also has a cover breech provided with a gunpowder cartridge shot needle to be set in the interior of the breech. The improvements are characterized because there's a breech's cover (13) with a shot inner device powered by a trigger (13a), this breech's cover (13) will be adapted for a quick hitch of the breech (12) set in the posterior end (10a) of the copier (10), the latter has a impact piston (11) provided with a radial handle (15) of retention for the return of the piston back-impact (11); in the copier (10) it's also foreseen a radial window (12a) for the liberation of the explosion's gases.

The present invention relates to an improvement for a device coupler of impact for an appliance of electrical connectors, particularly, to improvements made on device defined by a set of copier with a brace for support of the parts of the connectors to be set, the copier is made up by a piston with a breech that also has a cover breech provided with a gunpowder cartridge shot needle to be set in the interior of the breech, in a way that when it goes of the impact will be transferred to the piston which will be axial displayed in the copier and previously supported with its external free, together with a share of the connector's wedge to be locked with the connector's cover and also with the cables of energy which will be connected between one another.

It is generally known in the art that the use of the wedge connectors for connection area of electrical cables is necessary because it allows the tangential retention of the auxiliary or by-pass electrical cables in a main system of electrical cables already installed.

These connectors will be set with the main electrical cable extended between the poles or transmission towers, on the following they will receive the outermost share of the by-pass or secondary cable which will be connected to the main cable. After this first part of the setting the part in a shape of wedge that is part of the connector is replaced, by impact, to the corresponding connector's cover in which is found the main and secondary cables of the power system that have been already set.

Usually for the accomplishment of this connection, by impact, the operator uses a device made of a set of copier with a brace for support of the parts of the connectors to be set, the copier is made up by a piston with a breech that also has a cover breech provided with a gunpowder cartridge shot needle to be set in the interior of the breech. When this gunpowder cartridge goes of the power of its explosion in the inside of the chamber allows the transfer of this power to the inner piston of the copier, in turn the copier transfers the impact to the share of the connector's wedge set in front of the piston's external free and the connector's cover.

Although is largely used, this conventional device of electrical connectors setting in systems of electrical cables areas presents a several disadvantages: the operator, that will be setting the connection, won't be in a comfortable position because, usually, the setting takes place along the electrical cables already installed in the poles or transmissions towers, which obligates the operator to remain hanging next to a power system with his hand busy holding the device for the connector's appliance and the impact hammer which is needed to start the detonation of the projectile previously set in the breech of the device in order to generate the impact for the replacement of the connector's wedge, the impact is guaranteed by the axial dislocation of the piston in relation to the device's copier.

Another inconvenient of this conventional device of connector's setting is about the fact that the gases generated by the explosion of the projectile goes towards the operator and it might cause some kind of damage and certainly will cause a discomfort.

Another inconvenient of this conventional device of electrical connector's setting is about the fact that the reload of the device with a new detonation cartridge will be a complex activity because the operator is hanging next to the system and will have to keep the balance at the installation place, and also, at the same time, hold the impact equipment, the device for the appliance or the connectors and still be able to manage to move in order to take of the used cartridge and replace it with a new one.

This and others objectives and advantages of the present invention are accomplished with improvements made on device for electrical connector's appliance which includes a set of copier with a accessory brace for support and setting of the parts of the connector to be applied in the power system of the electrical cables, the copier is made up by a piston with a breech that also has a cover breech provided with a gunpowder cartridge shot needle to be set in the interior of the breech. According to the present invention the improvements consist in providing a breech's cover with a shot inner device powered by a trigger, this breech's cover will be adapted for a quick hitch in the posterior end of the copier, which will allow the adaptation for a cartridge carrier and a cartridge puller, both axial displayed in the posterior end of the copier, to be lined up with the impact piston that will have a radial retention handle for return of the piston back-impact; it's also foreseen a radial window for the liberation of the explosion's gases guaranteeing that the release of those gases don't hit the operator of the tool in any case.

On the following the present invention will be described based on the attached Figures on which:

FIG. 1 represents a perspective view of the device for the appliance of the improved electrical connector;

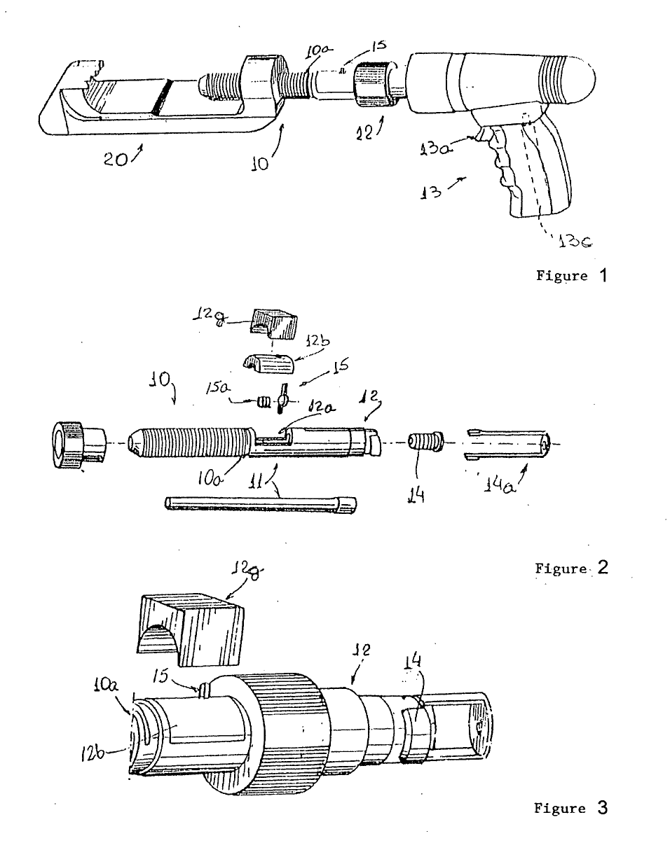

FIG. 2 represents a perspective view into pieces of the copier that is part of the tool for the appliance of the improved electrical connector, the copier's version in the figure is from the version provided with a cartridge carrier and a cartridge puller device;

FIG. 3 represents an amplified detail in perspective of the entrance end of the copier's set which is illustrated in the former figure;

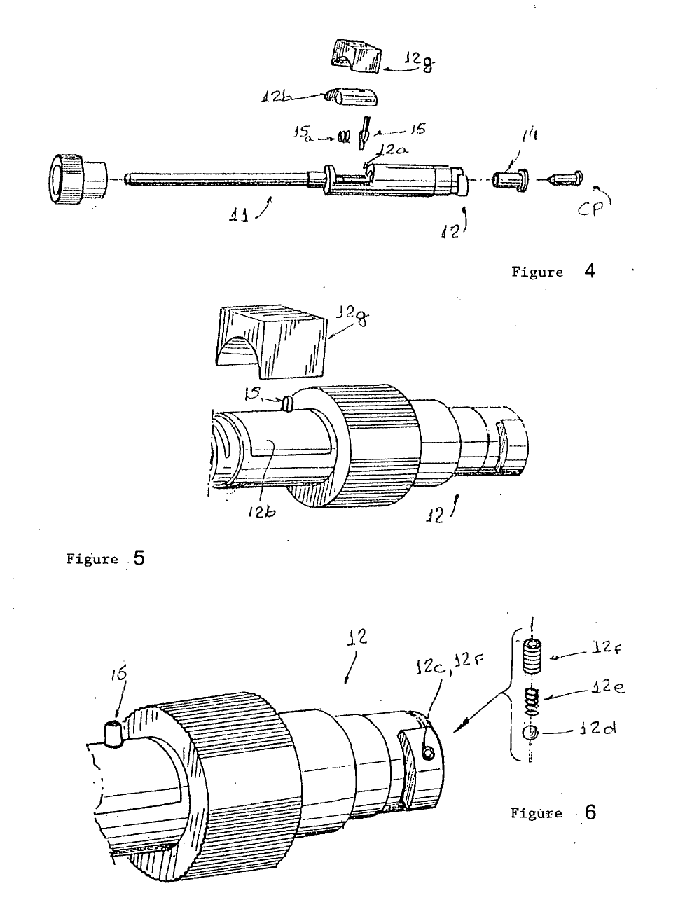

FIG. 4 represents a perspective view into pieces of the copier's set that is part of the device for the appliance of the improved electrical connector, the copier's version in the figure is from the version provided with a cartridge carrier but without a cartridge puller device;

FIG. 5 represents an amplified detail in perspective of the entrance end of the copier's set which is illustrated in FIG. 4;

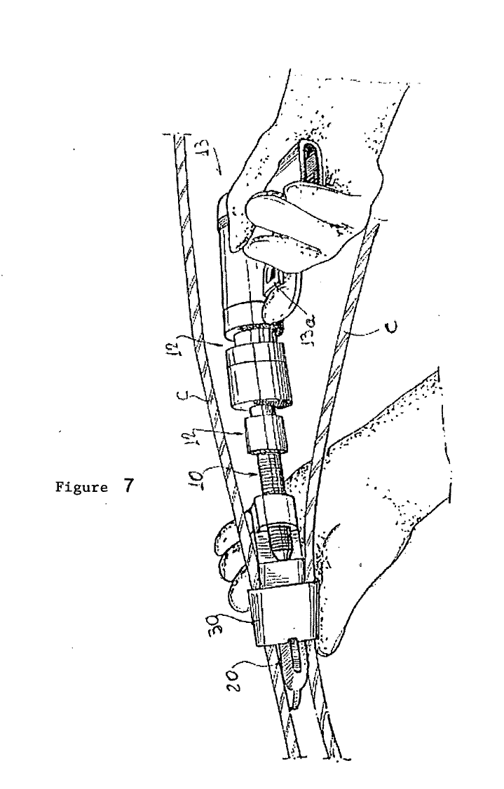

FIG. 6 represents a partial and amplified detail of the copier's end, being illustrated into pieces the retention cartridge carrier mechanism illustrated in FIG. 8;

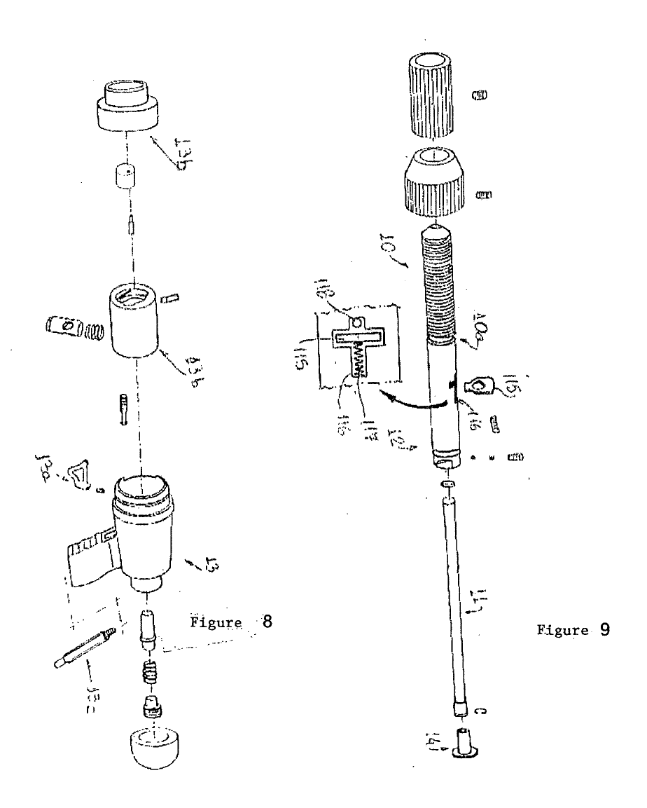

FIG. 7 represents a perspective view of the device for the appliance of the improved electrical connector displayed for use;

FIG. 8 represents a perspective view into pieces of a built variation of the copier's set that is part of the device for the appliance of the improved electrical connector, the copier's version in the figure is from the version provided with a cartridge carrier but without a cartridge puller device;

FIG. 9 represents a perspective view into pieces of the breech's cover or shooting unit that is part of the device for the appliance of the improved electrical connector;

According to the figures the improvements on the device for the appliance of the electrical connector, object of the present invention, are carried out by a device that includes a set of copier 10 with accessories brace 20 for support and connectors 30 parts setting to be applied into the power system between the electrical cables C. This copier 10 is made up by a piston 11 with a breech 12 where it's coupled the breech's cover or shooting unit 13 provided with a shooting needle of a gunpowder cartridge CP to be set in the inner part of the breech 12.

According to the present invention the improvements consist in the fact that the breech 12 will be set in a breech's cover 13, in the way of a gun, with a inner shooting device to be started by a trigger 13a, look over FIGS. 1, 7 and 9.

The breech's cover 13, in a first version, look over FIGS. 1 and 7, receives by a quick hitch the breech 12 set in the posterior end of the copier 10a; in the first version, look over FIGS. 2 and 3, the breech 12 receives the adaptation of the cartridge carrier 14 which guarantees the proper position of the explosive cartridge CP to be placed in the device and also makes easier the removal, after the burst of the shell, in order to achieve this result a cartridge puller 14a is used.

The cartridge 14 and the cartridge puller 14a are, both, carefully set in an axial way, in the posterior end or entrance of the breech 12. That way is guaranteed that the cartridge carrier 14 doesn't fall into the breech 12 when the device is turned into a vertical position, it's foreseen a small radial hole 12c at the end of the breech's 12 entrance, next to the place of the breech's 12 hitch with the breech's 13 cover; this hole 12c is set by a elastic retention mechanism, consisting in a sphere 12d, a helical spring 12e and a screw 12f, all set in this order in the interior of the hole 12c, therefore forming a permanent radial elastic pressure on the cartridge carrier 14 when it's placed on the orifice of the breech 12, look over FIG. 6.

This breech 12 lined up with the impact piston 11 presents a radial handle 15 which is defined by a transversal bolt wire with a intermediary ring shaped space crossed over by piston 11, which is this part also crosses over a retention piston 11 back-impact helical spring 15a. This way the previous set of the breech 12 is defined by a window 12a closed by a grooved top 12b in a way that the piston 11 is able to slide, always, axially forward in relation to the ring shaped space of the radial handle 15, being unable to move backwards by the action of the handle 15. On the window 12a of the breech 12 there's a silent block 12g, which guarantees the reduction of the device's noisy and allowing a better performance of the device in relation to the expansion and posterior release of the gases generated by the burst of the metallic cartridge CP, it also guarantees a redirection of the gases so it doesn't reaches, by any chance, the tool's operator.

In a second version, look over FIG. 9, the breech's cover 13 receives by a set of tubular gloves 13b the breech 12 set on the posterior end 10a of the copier 10. In this version, look over FIG. 8 the breech 12 receives the adaptation of the cartridge carrier 14 which guarantees the proper position of the explosive cartridge CP and also makes it easier its removal after the burst of the shell, in order to achieve this result a cartridge puller 13c is used, it's illustrated by FIGS. 1 and 9, it basically consist on a rod through which is introduced the cartridge carrier after its automation for the removal of the burst cartridge.

In the FIGS. 1 and 9 it's possible to see the cleaning rod 13c of the cartridge carrier 14 which is placed in the grip of the breech's cover 13.

As seen in FIG. 8, the breech 12, lined up with the impact piston 11, presents a radial key 115 defined by a small laminated plate with a narrow lower end and a superior set widen, provided with a hole, through which the piston 11 is crossed over. The key 115 is placed on the transverse part of a cross key bed 116 foreseen in the superior face of the breech 12, look over detailed FIG. 8, the key 115 is forced forward by the action of the helical spring 117, that acting upon the key 115, stops the return of the impact piston 11, the piston 11 receives a transverse pin lock 118, on the front part of the key 115, look over the detail of FIG. 8. In this way, the piston 11 is able to slide, always, axially forward in relation to the ring shaped space of the key 115, being blocked when it moves back by the action of the pin handle 118 on the key itself.

For both versions of the device, with or without the cartridge puller 14a, the procedures in order to operate the device coupler follows this steps: with the cartridge carrier 14, the operator has to adjust the set made of the copier 10 and the breech 12, in the head or the appliance support 20. On the latter, the pieces that are part of the electrical connector 30 and its respective conductors' cables C have to be fitted in. The operator threads the copier 10 forward until the frontal part of the copier 10 gets in touch with the back part of the wedge that is part of the connector 30, being the piston 11 totally gathered towards the inner part of the copier 10. On the following the operator places the metallic cartridge with gunpowder CP in the cartridge's carrier 14 housing and after that trigs the breech's cover 13 with a inner shooter next to the end of the entrance of the breech 12, look over FIG. 6.

The shot of the metallic cartridge CP is accomplished by the first right hand spin move of the breech's cover 13 followed by a forward move of the breech's cover 13, this way the trigger 13a is released and it leads to the burst of the cartridge CP. Therefore the piston 11 is forced forward pushing the wedge piece of the connector 30 to the inner part of its complementary piece in a shape f a “C”, locking each other and keeping between themselves the electrical cable C.

After the shooting and the setting of the electrical connector 30, the user displaces the cartridge with the help of the cartridge puller device 14a, which is in a shape of a clamp and will take out the cartridge in the inside of the breech. Like that the piston 11 will remain in the interior of the copier 10 by the action of its retention handle 15.

It's necessary to point out that the cartridge carrier 14 can have its outer part threaded or even depending on the version of the device to be used.

Although described and illustrated in a chosen constructive conception, it's possible to make changes in the project and it can be accomplished without losing the original scope of the present invention.

1. A device coupler of impact to connect aerial handles of electric energy, such as the type that exists in a set of copier with an accessory brace for support and setting of the parts of the connector to be applied in the power system of the electrical cables, the copier is made up by a piston with a breech that also has a cover breech provided with a gunpowder cartridge shot needle to be set in the interior of the breech, the improvements are characterized because there's a breech's cover (13) with a shot inner device powered by a trigger (13a), this breech's cover (13) will be adapted for a quick hitch of the breech (12) set in the posterior end (10a) of the copier (10), the latter has a impact piston (11) provided with a radial handle (15) of retention for the return of the piston back-impact (11); in the copier (10) it's also foreseen a radial window (12a) for the liberation of the explosion's gases.

2. The device coupler of impact to connect aerial handles of electric energy, according to claim 1, wherein the breech's cover (13) has the shape of a pistol with a inner shooting device powered by a trigger (13a).

3. The device coupler of impact to connect aerial handles of electric energy, according to claim 1, wherein the breech (12) receives the adaptation of the cartridge carrier (14) which guarantees the proper position of the explosive cartridge (CP) to be placed in the device, also making its removal easier after the burst of the shell, in order to achieve this result a cartridge puller (14a) is used.

4. The device coupler of impact to connect aerial handles of electric energy, according to claim 3, wherein the cartridge (14) and the cartridge puller (14a) are both carefully set in a axial way, in the posterior end or entrance of the breech 12.

5. The device coupler of impact to connect aerial handles of electric energy, according to claim 3, wherein a small radial hole (12c) at the end of the breech's (12) entrance, next to the place of the breech's (12) hitch with the breech's (13) cover; this hole (12c) is set by a elastic retention mechanism, therefore forming a permanent radial elastic pressure on the cartridge's (14) door when it's placed on the orifice of the breech (12).

6. The device coupler of impact to connect aerial handles of electric energy, according to claim 4, wherein a small radial hole (12c) is disposed at the end of the breech's (12) entrance, next to the breech (12) hitch with the breech (13) cover, the hole (12c) being set by a elastic retention mechanism, forming a permanent radial elastic pressure on the cartridge's (14) door when placed on the orifice of the breech (12).

7. The device coupler of impact to connect aerial handles of electric energy, according to claim 5, wherein the elastic retention mechanism of the cartridge carrier (14) comprises in a sphere (12d), a helical spring (12e) and a screw (12f), all disposed et in this order in the interior of the hole (12c).

8. The device coupler of impact to connect aerial handles of electric energy, according to claim 1, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

9. The device coupler of impact to connect aerial handles of electric energy, according to claim 2, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

10. The device coupler of impact to connect aerial handles of electric energy, according to claim 3, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

11. The device coupler of impact to connect aerial handles of electric energy, according to claim 4, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

12. The device coupler of impact to connect aerial handles of electric energy, according to claim 5, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

13. The device coupler of impact to connect aerial handles of electric energy, according to claim 6, wherein the breech (12) lined up with the impact piston (11) presents a radial handle (15) which is defined by a transversal bolt wire with a intermediary ring shaped space crossed over by piston (11), which is this part also crosses over a retention piston (11) back-impact helical spring (15a); being the previous set of the breech (12) defined by a window (12a) closed by a grooved top (12b) allowing the piston (11) to slide, always, axially forward in relation to the ring shaped space of the radial handle (15), being unable to move backwards by the action of the handle (15).

14. The device coupler of impact to connect aerial handles of electric energy, according to claim 7, wherein on this window (12a) there iss a silent block (12g), guaranteeing a reduction of the device's noisy and also allowing a better performance of the device in relation to the expansion and posterior release of the gases generated by the burst of the metallic cartridge CP, it also guarantees a redirection of the gases so it doesn't reaches, by any chance, the tool's operator.

15. The device coupler of impact to connect aerial handles of electric energy, according to claim 3, wherein the cartridge carrier (14) has an even outer part.

16. The device coupler of impact to connect aerial handles of electric energy, according to claim 3, the cartridge carrier (14) has a threaded outer part.

17. The device coupler of impact to connect aerial handles of electric energy, according to claim 1, wherein the breech cover (13) receives by a set of tubular gloves (13b) the breech (12) set on the posterior end (10a) of the copier (10).

18. The device coupler of impact to connect aerial handles of electric energy, according to claim 1, wherein the breech (12) lined up with the impact piston (11), presents a radial key (115) defined by a small laminated plate with a narrow lower end and a superior set widen, provided with a hole, through which the piston (11) is crossed over; this key (115) is placed on the transverse part of a cross key bed (116) foreseen in the superior face of the breech (12); this key (115) is forced forward by the action of the helical spring (117), that acting upon the key (115), stops the return of the impact piston (11), due to a transverse pin lock (118) set on the front part of the piston (11) in front or the key (115).

19. The device coupler of impact to connect aerial handles of electric energy, according to claim 1, further comprising a cleaning needle (13c) of the cartridge carrier (14) which is placed in the grip of the breech's cover (13).
